(19) United States
(12) Patent Application Publication
(10) Pub. No.: US 2007/0081342 A1
(43) Pub. Date: Apr. 12, 2007

(54) System and method for mounting a light emitting diode to a printed circuit board

(76) Inventor: Oliver Szeto, Bensalem, PA (US)

Correspondence Address: LAMORTE & ASSOCIATES P.C., P.O. BOX 434, YARDLEY, PA, 19067, US

(21) Appl. No.: 11/545,002

(22) Filed: Oct. 7, 2006

Related U.S. Application Data
(60) Provisional application No. 60/724,260, filed on Oct. 7, 2005.

(51) Int. Cl. F21V 29/00

(52) U.S. Cl. 362/294

(57) ABSTRACT

A light emitting diode (LED) array that is configured to minimize heat damage to the LEDs during both the manufacturing of the array and the use of the array. The LED array utilizes a circuit board. The top surface of the circuit board contains a mounting area for retaining a light emitting diode. A plurality of separate thermal conduits extend through the circuit board within the mounting area. A light emitting diode is mounted to the top surface of the circuit board within the mounting area. The light emitting diode is contacted by the plurality of thermal conduits. The thermal conduits conduct heat away from the LEDs as the LEDS are in operation. Furthermore, the plurality of thermal conduits can be created with little or no thermal shock to the LEDS.

### RELATED APPLICATIONS

This application claims priority of U.S. Provisional Patent No. 60/724,260, entitled LED Mounting System And Method, filed Oct. 07, 2005.

### BACKGROUND OF THE INVENTION

1. Field of the Invention

In general, the present invention relates to the methods used to connect a light emitting diode to a printed circuit board. More particularly, the present invention relates to the structure of the printed circuit board and the manner utilized to dissipate heat from the light emitting diode on the circuit board structure.

2. Prior Art Description

Light emitting diodes (LEDs) have been available since the early 1960's in various forms and are now widely used for illumination and display purposes. LEDs produce light in a variety of colors and have very high operational efficiencies in lumens per Watt. Furthermore, LEDs can be made very small using solid-state circuit manufacturing techniques. The result is that LEDs provide light using much less space and much less power than traditional incandescent light bulbs.

Although LEDs have many advantages over a traditional incandescent lights, there are also a few disadvantages. One of the most predominant disadvantages is thermal sensitivity. LEDs exhibit a substantial light output sensitivity to temperature, and are permanently degraded by excessive temperature. Recent developments in LED technology have extended the maximum recommended operating temperature to 85 degrees Centigrade. LED devices, which incorporate the element Indium in their chemistries, exhibit typical (half brightness) lives on the order of 100,000 hours at 25 degrees Centigrade. However, degradation above 90 degrees C. is very rapid as the LEDs degrade exponentially with increases in temperature. Such high temperatures are not unusual for an LED operating environment. For example, traffic signal housings exposed to full summer sun can reach interior temperatures of 80 degrees Centigrade. without any internally generated heat load. A thermal rise of only 20 degrees Centigrade, due to LED operation, will stress the LEDs well beyond their sanctioned operating range.

Permanent thermal degradation of LEDs also occurs during array fabrication, when the LEDs are soldered to the supporting and/or interconnecting circuit board. Typical soldering temperatures (250 degrees Centigrade) can significantly degrade the LED array before it is even put into service. LED manufacturers recommend the use of lead wires of sufficient length to prevent excessive heat transmission from the soldering operation into the LED structure. Of course, the added lead wire acts detrimentally during LED operation, as the longer lead wires increase the thermal resistance and adversely affect the rejection of self-generated heat. Surface mounted LEDs are even more difficult to solder without damage, as their leads are more closely thermally coupled to the LED than in other package styles.

In the prior art, attempts have been made to provide heat management systems in LED mounting configurations. An example of such a prior art system is described in U.S. Pat. No. 6,966,674 to Tsai, entitled Backlight Module And Heat Dissipation Structure Therefore. In the Tsai patent, a circuit board configuration is provided with large holes. LEDs are mounted to a circuit board directly atop each hole. The holes are then filled with solder. The use of a large hole exposes a large portion of the LED to excessive heat during the solder process. If the hole is made smaller, however, the heat generated by the LED cannot be effectively conducted away. A balance must therefore be made between a hole that is too large and a hole that is too small. The result is a compromise that neither protects the LED well during soldering nor conducts heat away from the LED well enough during operation.

In U.S. Pat. No. 5,857,767 to Hochstein, entitled Thermal Management System For LED Arrays, a mounting system is described where large holes are left open under each LED on a circuit board. Although the presence of the open holes helps protect the LEDs during soldering, the open holes are very poor conductors of heat during LED operation. Accordingly, again the size of the hole becomes a compromise that neither protects the LED well during soldering nor conducts heat well during operation.

A need therefore exists for a system and method of mounting an LED to a printed circuit board that limits the exposure of heat to the LED during soldering yet enables excess heat generated by the LED to be conducted away from the LED during operation. This need is met by the present invention as described and claimed below.

### SUMMARY OF THE INVENTION

The present invention is a light emitting diode (LED) array that is configured to minimize heat damage to the LEDs during both the manufacturing of the array and the use of the array. The LED array utilizes a circuit board. The top surface of the circuit board contains a mounting area for retaining a light emitting diode.

A plurality of separate thermal conduits extend through the circuit board within the mounting area. A light emitting diode is mounted to the top surface of the circuit board within the mounting area. The light emitting diode is contacted by the plurality of thermal conduits. The thermal conduits conduct heat away from the LEDs as the LEDS are in operation. Furthermore, the plurality of thermal conduits can be created with little or no thermal shock to the LEDS.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of an exemplary embodiment of the present invention;

FIG. 2 is an exploded view of the exemplary embodiment of FIG. 1;

FIG. 3 is a cross-sectional view of the exemplary embodiment of FIG. 1;

FIG. 4 is a schematic of a method of manufacture; and

FIG. 5 is a cross-sectional view of an alternate embodiment of the present invention.

### DETAILED DESCRIPTION OF THE DRAWINGS

Although the present invention mounting system can be used to mount a single LED to a printed circuit board, it is particularly well suited for attaching an array of LEDs to a single circuit board. Accordingly, the exemplary embodiment of the present invention that is illustrated and described contains multiple LEDs. Such a configuration is merely exemplary and it will be understood that the present invention can be practiced to attached one, or any plurality of LEDs to a printed circuit board.

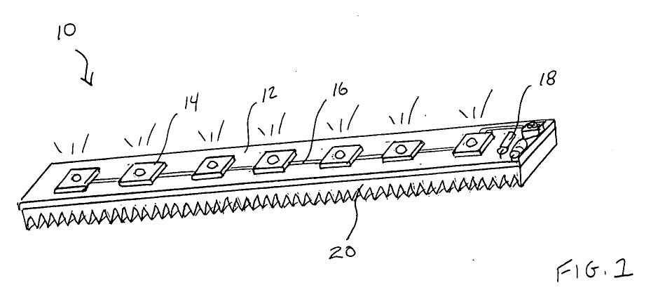

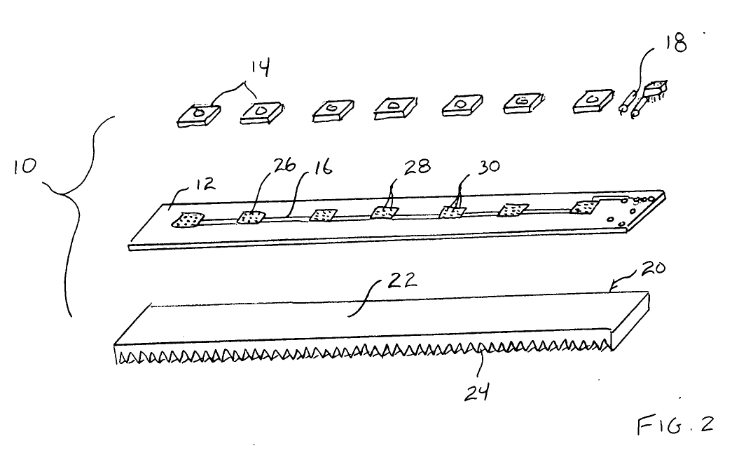

Referring to FIG. 1 in conjunction with FIG. 2, there is shown an exemplary embodiment of a lighting array 10. The lighting array 10 contains a printed circuit board 12. Upon the printed circuit board 12 are mounted a plurality of light emitting diodes (LEDs) 14. Conductive pathways 16 are present on the printed circuit board 12 to enable the flow of power to the LEDs 14. Other circuitry 18 can also be mounted to the circuit board 12 that may be used to activate and/or control the operation of the LEDs 14.

A least one heat sink 20 is provided. The heat sink 20 can have many forms, such as an external housing of a light assembly. However, in the shown embodiment, the heat sink 20 has a traditional structure with a flat top surface 22 and a vained bottom surface 24 that increases its heat exchange characteristics. The circuit board 12 rests upon the heat sink 20. Accordingly, the heat sink 20 absorbs and dissipates heat generated by the LEDs 14 and the other circuitry 18 mounted to the circuit board 12.

On the circuit board 12, there are mounting areas 26 where the LEDs 14 mount to the printed circuit board 12. The conductive pathways 28 that provide power to the LEDs 14 travel to and from the mounting areas 26. Accordingly, when an LED 14 is placed onto one of the mounting areas 26, the LED 14 contacts the conductive pathways 28 and becomes electrically operative.

A matrix of holes 30 are formed through the printed circuit board 12 in each mounting area 26 of an LED 14. The holes 30 are small, wherein each hole 30 defines a horizontal, cross-sectional area that is less than ten percent of the footprint of the LED 14. Accordingly, it will be understood that a plurality of holes 30 directly contact the printed circuit board 12 below each of the LEDs 14 that are mounted to the circuit board 12.

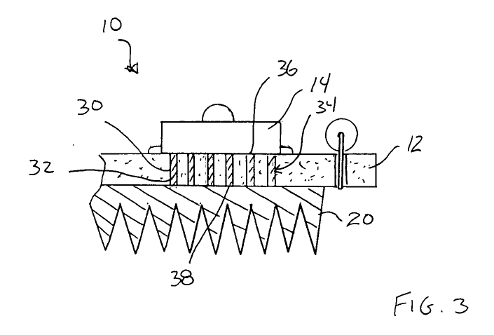

Referring to FIG. 2, in conjunction with FIG. 3, it can be seen that within the lighting array 10, the holes 30 under each LED 14 are filled with solder or another thermally conductive material 32. The holes 30, therefore, become a series of thermally conductive conduits 34 that extend in parallel through the structure of the circuit board 12. The top surface 36 of each thermally conductive conduit 34 contacts the underside of an LED 14. The bottom surface 38 of each thermally conductive conduit 34 is exposed on the bottom of the printed circuit board 12 and contacts the heat sink 20 that is mounted to that surface. The thermally conductive conduits 34, therefore, provide a direct thermal pathway from the LED 14 to the heat sink 20 through the structure of the circuit board 12. However, since each thermally conductive conduit 34 is small, the creation of the thermally conductive conduits 34 do not significantly heat the LED 14. Yet, due to the number of thermally conductive conduits 34 that are present under each LED 14, the thermally conductive conduits 34 combine to provide a significant thermal drain to the LED 14 during the operation of the LED 14.

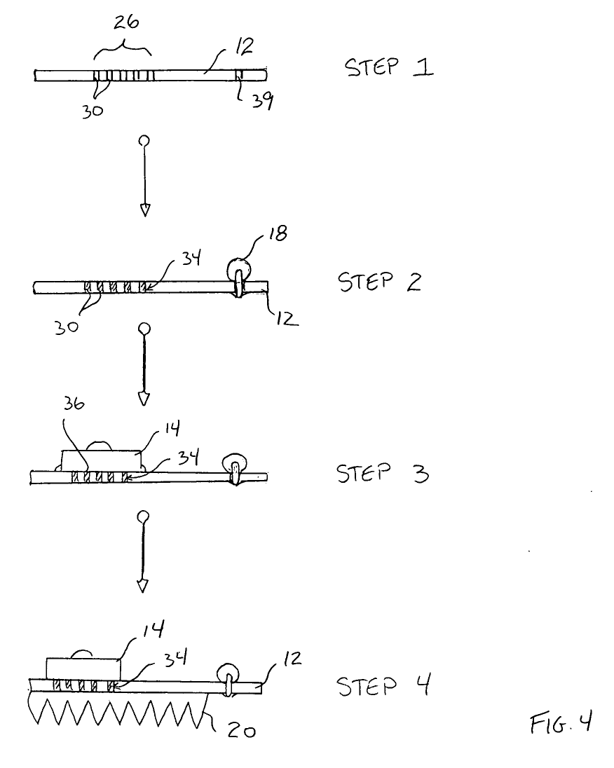

Referring to FIG. 4, an exemplary method of manufacture can be explained. As is indicated in Step 1, a circuit board 12 is provided. The circuit board 12 contains the various holes 30 under the LED mounting areas 26 as well as other soldering holes 39 used for supplemental circuitry 18. The supplemental circuitry 18 is added to the circuit board 12. As is indicated by Step 2, the circuit board 12 is passed through a wave solderer (not shown) that fills all the holes 30 in the circuit board 12 with solder. The solder fills the holes 30 in each LED mounting area 26, therein creating a plurality of parallel thermally conductive conduits 34.

As is indicated by Step 3, the LEDs 14 are attached to the top of the printed circuit board 12. The LEDs 14 contact the top surface 36 of each of the thermally conductive conduits 34 in each mounting area 26. Since the solder filling the holes 30 is already set, the LEDs 14 are not subjected to the heat of the wave-soldering machine. Rather, the leads of the LEDs 14 are spot soldered to the top of the printed circuit board 12 using traditional surface mounting techniques, therein causing little or no heat damage to the body of the LED 14.

Lastly, as is indicated by Step 4, at least one heat sink 20 is attached to the bottom of the printed circuit board 12, wherein the thermally conductive conduits 34 under each LED 14 contact the heat sink 20 and provide a direct thermal pathway between the LEDs 14 and the heat sink 20.

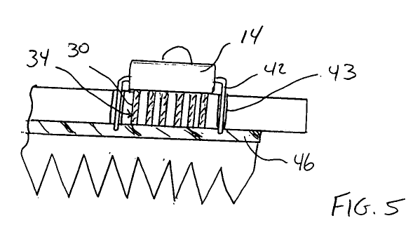

In the methodology expressed by FIG. 4, the LEDs 14 are surface mounted devices that are attached to the top of the printed circuit board 12. It should be understood that the LEDs 14 need not be surface mounted devices. Rather, the LEDs 14 can have wire leads that extend into lead soldering holes in the printed circuit board. Referring to FIG. 5, such an embodiment is shown. In this embodiment, each LED 14 has leads 42 that extend into soldering holes 43. The LEDs 14, therefore, are set onto the printed circuit board 12 before the printed circuit board 12 passes through a wave-soldering machine. When the printed circuit board 12 passes through the wave-soldering machine, the holes 30 under the LED 14 and the solder holes 43 holding the wire leads 42 become filled with solder. Since the holes 30 defining the thermally conductive conduits 34 are small, only very small volumes of solder are exposed to the underside of the LED 14 during the soldering process. The heating of the LED 14 by the solder is minimized and produces only negligible adverse effects to the performance of the LED 14.

Since the wire leads 42 of the LED 14 pass through the printed circuit board 12 and are present on the bottom of the printed circuit board 12, an insulating pad 46 must be provided under the circuit board 12 to prevent the wire leads 42 from shorting against the heat sink 20. The insulating pad 46 is made from a highly thermally conductive material that is dielectric. As such, the insulating pad 46 enables heat to be dissipated from the thermally conductive conduits 34 into the heat sink 20 without concerns of electrical shorting.

It will be understood that the embodiments of the present invention that are illustrated and described are merely exemplary and that a person skilled in the art can make many variations to those embodiments. For instance the number of thermal conduits present under each LED can be altered. It is preferred that the total area of the thermal conduits contacting the bottom of any LED be between 30% and 70% of the total footprint area of the LED. It should also be understood that the shape of the printed circuit board and the number of LEDs mounted to the printed circuit board are a matter of design choice and can be altered to meet the specific needs of a manufacturer. All such variations, modifications and alternate embodiments are intended to be included within the scope of the present invention as set forth by the claims.

What is claimed is:

1. An LED assembly, comprising:
a circuit board having a top surface and a bottom surface, said top surface having at least one mounting area for retaining at least one light emitting diode, wherein said circuit board defines a plurality of holes that extend through said circuit board in each said mounting area; and
a light emitting diode mounted to said top surface of said circuit board in each said mounting area, wherein said light emitting diode covers each of said holes disposed in said mounting area.

2. The assembly according to claim 1, wherein said holes are filled with a metal, therein creating a plurality of thermal conduits that extend through said circuit board from said top surface to said bottom surface.

3. The assembly according to claim 2, further including a heat sink coupled to said bottom surface of said circuit board, wherein said heat sink contacts each of said thermal conduits under each said mounting area.

4. The assembly according to claim 3, wherein said light emitting diode has leads that extend through said circuit board.

5. The assembly according to claim 4, further including a thermally conductive and electrically insulating pad disposed between said heat sink and said bottom of said circuit board.

6. A method of fabricating an LED assembly, said method comprising the steps of:
providing a circuit board having a top surface, a bottom surface and a mounting area on said top surface for receiving a light emitting diode, wherein a plurality of holes are disposed in said circuit board between said top surface and said bottom surface within said mounting area; and
mounting a light emitting diode to said circuit board in said mounting area, wherein said light emitting diode covers said plurality of holes.

7. The method according to claim 6, further including the step of filling said plurality of holes with metal, therein forming a plurality of thermally conductive conduits that extend between said top surface and said bottom surface of said circuit board under said light emitting diode.

8. The method according to claim 7, further including the step of providing a heat sink and attaching said heat sink to said bottom surface of said circuit board.

9. The method according to claim 8, wherein said heat sink contacts said thermally conductive conduits.

10. The method according to claim 7, wherein said step of filling a plurality of holes with metal includes passing said circuit board through a wave soldering machine, wherein said plurality of holes fill with molten solder.

11. The method according to claim 6, wherein said step of mounting a light emitting diode to said circuit board includes surface mounting said light emitting diode to said circuit board.

12. The method according to claim 6, wherein said light emitting diode has leads and said step of mounting a light emitting diode to said circuit board includes soldering said leads into soldering holes within said circuit board.

13. A heat dissipating illumination assembly, comprising:
a circuit board having a top surface and a bottom surface, said top surface having a mounting area for retaining a light emitting diode;
a plurality of separate thermal conduits extending through said circuit board from said top surface to said bottom surface within said mounting area; and
a light emitting diode mounted to said top surface of said circuit board in said mounting area, wherein said light emitting diode is contacted by said plurality of separate thermal conduits.

14. The assembly according to claim 13, further including a heat sink coupled to said bottom surface of said circuit board, wherein said heat sink contacts said plurality of separate thermal conduits.

15. The assembly according to claim 13, wherein said thermal conduits are holes in said circuit board that are filled with metal.

16. The assembly according to claim 15, wherein said metal is solder.
